(19) United States
(12) Patent Application Publication
(10) Pub. No.: US 2011/0161905 A1
(43) Pub. Date: Jun. 30, 2011

(54) Layout Electromagnetic Extraction For High-Frequency Design And Verification

(75) Inventors: Jinsong Zhao, Palo Alto, CA (US); Liang Tao, Campbell, CA (US); Michael Simbirsky, Santa Clara, CA (US)

(73) Assignee: LORENTZ SOLUTION, INC., Santa Clara, CA (US)

(21) Appl. No.: 12/983,881

(22) Filed: Jan. 3, 2011

Related U.S. Application Data
(60) Provisional application No. 61/291,836, filed on Dec. 31, 2009.

(51) Int. Cl. G06F 17/50

(52) U.S. Cl. 716/115

(57) ABSTRACT

Embodiments of the present invention provide a method of circuit design and circuit simulation. A method for electromagnetic simulation of passive structures of a circuit design is disclosed. The method comprises recognizing one or more geometries of the passive structures having certain geometric properties and electromagnetic properties, converting the one or more geometries to one or more primitives based on the geometric properties and numerically equivalent electromagnetic properties of the passive structures, constructing a physical topology incorporating the converted primitives and unconverted geometries, and simulating the physical topology to generate electromagnetic modeling of the passive structures of the circuit design.

### RELATED APPLICATION

The subject matter of this application claims priority from U.S. Provisional Application 61/291,836 entitled “Layout Electromagnetic extraction for High-Frequency Design and Verification”, by inventors Jinsong Zhao, Liang Tao and Michael Simbirsky, which was filed on Dec. 31, 2009.

### BACKGROUND

1. Technical Field

This disclosure generally relates to circuit design and simulation. More specifically, this disclosure relates to generation of electromagnetic modeling elements to simulate high speed electrical circuits.

2. Related Art

In integrated circuit design, especially those circuits that operate at high frequencies, accurate modeling and verification of passive structures, including passive device and interconnects, are essential for the prediction of circuit behavior before committing to real manufacturing. Numerical modeling of passive structures typically relies on solving Maxwell's equations, a process hereby noted as electromagnetic (EM) simulation. Since electromagnetic simulation can be degenerated into static capacitance extraction and static inductance extraction, in the description of this invention, it is understood that electromagnetic simulation or electromagnetic extraction includes its static version without loss of generality. A traditional EM solver has a four part data flow. The first part is to provide the problem specification (geometric information, source information, and output information). Next, discretize the geometries into the basic interaction elements. The third part is to build up the internal data structures, leading a system matrix. The fourth part is to scan through the sources and solve matrix and right hand sides.

Based on how the Maxwell's equations are represented, there are two types of numerical solvers that can be used: integral equation solver and differential equation solver. In order to reach reasonable accuracy, each solver involves one critical step called discretization, in which the physical geometries, sometimes including the dielectric structures, will be decomposed into many basis elements. Then the electromagnetic equations are thus represented by the corresponding linear equations to be solved in a system matrix format. Thus the time needed to arrive at the numerical solution has two parts: system matrix construction time and system matrix solving time. It has become common that complex integrated circuit geometries lead to massive discretization that further results in huge amount of computational time on system matrix construction and system matrix solving.

A variety of numerical methods, such as Method of Moments, Finite-element, Finite-Difference Time-Domain, can be an underlying method for the EM solver. Each of these EM methods involves one step called discretization, in which the physical geometries, sometimes including the dielectric structures, will be broken down into basic elements such as triangulation, grids, and other basis elements.

EM technologies have long been used to design and model passive devices and interconnect on integrated circuits. In the design automation environment, there exists a strong need to electromagnetically model the raw layout data in the integrated circuit design without manual intervention. One example of the application is the passive device integrity check, where a raw passive device layout is passed to an EM system which is to analyze the layout for its EM behavior. Any accidental layout short or open can be detected by the undesired model produced by such system. Not only such EM system can be used to produce EM models for the device under analysis, such EM system is vitally important to check the integrity so as to avoid committing to silicon manufacturing when devices are checked to be not compliant to design specification.

Unfortunately, application of the above mentioned traditional EM solvers to real integrated circuit designs for small process geometries can be very slow as the geometries in the layout can be prohibitively complex for practical use of EM solvers to solve and converge. The main difficulties inherent in the traditional EM solvers are:

A) the brute-force use of EM solver technologies has to make the worse-case assumption such as the current flows in all directions whereas in reality the design intention is that the current flows on the layout path; and

B) the brute-force use of EM solver technologies has to handle process-related geometries, such as via, slotting, metal fills and guard rings, as part of the intended EM structures. These process-related structures massively complicate the real problem to be computed electromagnetically.

Therefore, there is a need to accelerate the layout EM modeling through a preprocessing step called layout EM extraction (LEM) that overcomes current challenges encountered by circuit designers and circuit simulators.

### SUMMARY OF INVENTION

This invention provides a modeling and extraction capability in a circuit design and simulation environment that allows for accurate high-frequency models for passive structures, including passive device and interconnects. The present invention recognizes the layout and decomposes the original layout into efficient EM Components and their respective connections. EM Components are defined as the building blocks supported by the EM solver to produce high-quality results with high efficiency. Current EM solvers already support such EM Components or can be enhanced to support those special EM Components, thus this invention can be applied inside existing EM solvers as well as part of a flow that enables existing EM solvers to handle the original complex layout geometries for EM design and verification.

It is recognized that complex layout geometries cannot be practically modeled through brute-force application of electromagnetic solvers. Instead, a layout extraction mechanism is devised to process complex layout geometries (including multilayer polygons, complex via arrangements, slotting and metal fill structures) and convert the complex layout geometries into EM Components and connections. The EM components and connections serve as the electromagnetic representation of the physical structures and allow for electromagnetic solvers to take in as input and produce corresponding electromagnetic models. One aspect of the present invention is the intelligent decomposition of layouts to path primitives and rest polygons etc., thereby allowing for dramatic simplification of electromagnetic modeling compared to the traditional polygon and discretization-based electromagnetic modeling. Another aspect of the present invention is the intelligent recognition of via groups, guard rings, slotting and metal fills such that efficient electromagnetic modeling can be applied to those special structures.

Accordingly, an embodiment of the present invention provides a method for electromagnetic simulation of passive structures of a circuit design. The method comprises recognizing one or more geometries of the passive structures having certain geometric properties and electromagnetic properties, converting the one or more geometries to one or more primitives based on the geometric properties and numerically equivalent electromagnetic properties of the passive structures, constructing a physical topology incorporating the converted primitives and unconverted geometries, and simulating the physical topology to generate electromagnetic modeling of the passive structures of the circuit design.

In accordance with another aspect of the present invention, the recognizing step, one or more vias connected to the same primitives having a predetermined distance from one or more other vias of the same primitives are identified as a group. A viapoly of the group is created as a primitive.

In accordance with another aspect of the present invention, in the recognizing step, one or more paths and rest polygons are identified. The paths define a polygon using a center line and a distance from the center line.

In accordance with another aspect of the present invention, in the recognizing step, one or more metal fills are identified. The metal fills are equivalently modeled as a group of polygons on the same metal layer and not connected to ports of the passive structures and are at a predetermined distance with each other.

In accordance with another aspect of the present invention, in the recognizing step, one or more slots in the metal structures are identified. The slots are equivalently modeled as an effective reduction of conductivity attached to the primitives of a same enclosure and on a solid same metal layer.

In accordance with yet another aspect of the present invention, the converting step, one or more types of primitives are converted based on different accuracy and extraction criteria.

In yet another aspect of the present invention, the simulating step, one or more independent or integrated electromagnetic solvers are used to generate the electromagnetic modeling of the passive structures. A combination of one or more independent or integrated electromagnetic solvers and static solvers are used for the modeling of the passive structures.

### BRIEF DESCRIPTION OF THE DRAWINGS

FIG. 1 illustrates data flow for EM extraction;

FIG. 2 illustrates a flow chart to find paths from raw polygons;

FIGS. 3a-b illustrate path with slotting;

FIG. 4 illustrates vias between layers;

FIG. 5 illustrates via group at the end of path;

FIGS. 6a-c illustrate an extraction of via path in accordance with an embodiment of the present invention;

FIG. 7 illustrates a via groups that connects two polygons;

FIG. 8 illustrates a flow chart handling multiple layers in accordance with an embodiment of the present invention;

FIG. 9 illustrates metal fill example in accordance with an embodiment of the present invention;

FIG. 10 illustrates a contour polygon of metal fills in accordance with an embodiment of the present invention;

FIG. 11 illustrates a another via group example in accordance with an embodiment of the present invention; and

FIG. 12 illustrates a use or text to recognize terminals in accordance with an embodiment of the present invention.

### DETAILED DESCRIPTION

### Layout Electromagnetic Extraction

Layout EM (LEM) extraction is to analyze the raw input design layout, decompose the original layout into EM Components that have efficient EM properties, and output (either in memory or through file transfer) a format that is acceptable to an EM solver. Because the input to the EM solver is the efficient EM Components (or a representation of the EM Components) rather than the original layout that is often prohibitively complex for EM simulation, the EM modeling is greatly accelerated.

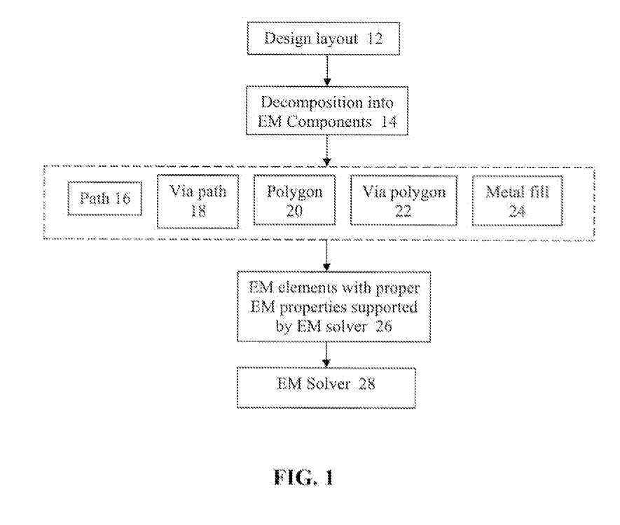

FIG. 1 shows a data flow for a normal layout EM extraction flow for a typical circuit design. The flow chart begins with step 12. The raw input design layout is analyzed. In step 14, the analyzed design layout is decomposed into EM Components with corresponding EM properties.

As an example of a set of EM Components that can be implemented for layout EM extraction, the EM Components that can be accelerated for EM modeling are explained as follows.

Path 16: it is typical for a path to conduct currents and thus a reasonable assumption is that current only flows in the direction of the path. Therefore, simplify the EM modeling burden by omitting the currents vertical to the current flowing direction. Further, if there are slotting in the path as represented by polygons inside the path, it can further decompose the path into a solid path and an array of polygon holes inside the path, and then the polygon holes are modeled as if the polygon holes are evenly distributed on the solid path, thereby using a very simple density concept to reduce the modeling complexity.

Via path 18: if a path on one layer exactly overlaps with a path on another layer through a group of vias, this structure can be recognized as via path. Knowing that paths connected by a group of vias can be modeled by only the two paths without regard to the current flowing effects of the vias (since the vertical current is very small), the modeling complexity is greatly reduced.

Polygon 20: if path searching and decomposition are exhausted, remaining will be polygons. For regular integrated circuit layout designs, polygon typically is a very small amount of decompositions. For efficiency purpose, a polygon can be modeled as an EM element, inductive element, capacitive element, or simply as a node, based on its size and adjacent EM Components size and model requirements.

Via polygon 22: when polygons on different layers are connected by a group of vias, a via polygon can be recognized so as to model the via arrangement as if it is a solid polygon instead of modeling the via individually, thereby greatly reducing the modeling complexity.

Metal fill 24: metal fills are typically spread on the layout structure to maintain the metal density requirements for yield enhancement purpose. Those metal fills are modeled as if they function as a solid polygon instead of modeling the metal fills individually.

In step 26, EM elements with proper EM properties support are supplied to EM solver. In step 28, EM solver simulates the EM elements based on the supplied EM properties to provide an EM modeling result.

While the above extensively describes how an EM engine might handle the EM Components, there is no inherent limit on the particular solvers that can be used. For example, the EM solver can be a very simple static parasitic extraction engine that only extracts resistance and capacitance. Thus, the layout EM extraction is a geometry preprocessing for a physics-based solving engine for wide applications.

Further, certain EM solvers accept a netlist format as its input in which instances are connected through nodes; EM Components can be implemented as a type of instance in those solvers. In the examples that follow, a netlist-based EM solver is used as an example to illustrate EM layout extraction, with the understanding that other EM solvers can be similarly applied after the layout EM extraction.

### Layout Decomposition

Implementation of layout EM extraction can vary. Three pieces are essential for layout EM extraction: path, multilayer handling of vias, and metal fills. Recognition of path from an arbitrary polygon is the most basic step in the LEM because path reflects the current flowing and electric connections that are most commonly used in integrated circuit designs. Certain paths might contain slots to accommodate metal density requirements, and recognition of those slots inside a solid path provides much more efficient use of EM modeling resource. Via structures connecting multilayers present modeling challenge if each via must be modeled individually; instead, a properly implemented LEM needs to group vias and model them as a group with a reasonable assumption. Metal fill structures are also used to accommodate metal density requirements, and the metal fill structure further present a huge modeling challenge if each metal fill tile has to be modeled individually; instead, a properly implemented LEM groups metal fills and models the metal fills as a group with reasonable assumption.

### A. Path Recognition

The basic step in the layout decomposition is to find the paths from raw polygons. FIG. 2 shows a flow chart to find the paths from raw polygons. The flow chart begins with step 30, polygon layout on single layer. Next, in step 33, find paths by finding parallel edges that are continuous to form paths. In step 36, cut paths from the original polygon in which the cuts become connectivity and remaining. Each pair of parallel edges is searched, and if pairs are found to be continuously connected, they form a path. In accordance to an embodiment of the present invention, numeric tolerance is added to accommodate the grid errors.

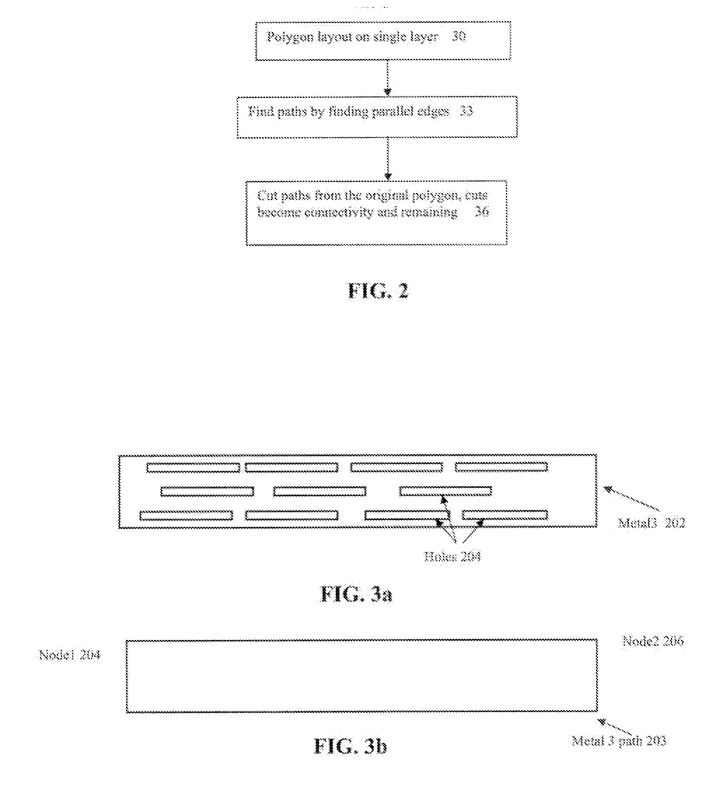

Certain paths can contain slots to accommodate metal density requirements, and recognition of those slots inside a solid path provides much more efficient use of EM modeling resource. FIGS. 3a-b show examples of a path with slotting. In FIG. 3a, a complicated metal 3 polygon is shown as metal3 202. Metal3 202 has many holes 204 inside the metal 3 polygon. The outline of metal 3 202 is a path. In FIG. 3b, LEM recognizes it as metal 3 path 203, and assign node1 204 and node2 206 to the end of the path. The property slotratio, which is defined as the ratio between the area of all holes and the area of path 203, is added to metal 3 path 203. The slotratio provides an effective reduction of conductivity based on slots inside the solid path.

The following shows the final output as an example of describing the path.

path(‘node1’,’node2’,name=’path0’,width=5e−6,layer=’metal3’,

point=[0,2.5e−06,10e−5,2.5e−6], trafo=[1.0,0.0,0.0,1.0,0.0,0.0],
slotratio=0.324)

In the above example, the slotratio of the path is 0.342, which means the area of all holes is 0.342 times of the area of the path. EM engine assumes the holes are evenly distributed along the path and use this simple density concept to reduce the modeling complexity

### B. Multilayer Handling

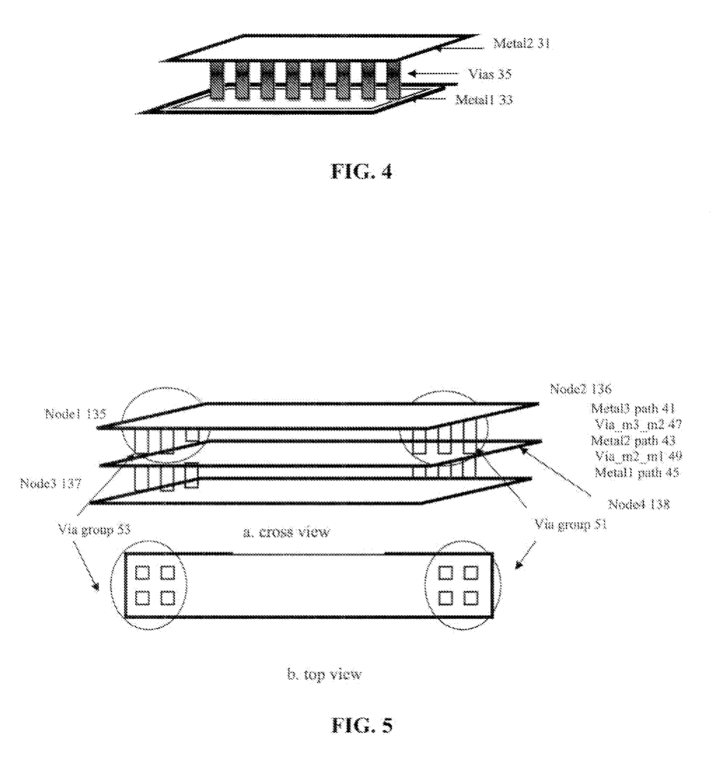

FIG. 4 shows multiple layers that are involved in a typical passive device design. Metal 2 layer 31 is connected with metal 1 layer 33 with vias 35. To reduce resistance and increase yields, designer usually places as many vias as possible. The many vias makes EM simulation very time-consuming if no approximation is made for the many vias. As an example, LEM approximates the many vias by grouping the vias which are close enough to each other together, thus greatly reducing simulation time without sacrificing accuracy.

In a typical layout, every via is covered by one or two metal elements (usually via is covered by two conducting layers but sometimes by one layer only). Most often one of these conducting elements is a path. In the present embodiment, a special curvilinear coordinate system is introduced. First coordinate (u) corresponds to so called “natural” coordinate along the path central line. Second coordinate (v) is orthogonal to the first coordinate.

In an example case of one-segment path, the curvilinear coordinate system coincides with standard Cartesian system but in other cases the system is more complicated. The curvilinear coordinate system is not extendable (cannot be defined) far beyond the path but such extension is not needed for clustering purposes. However, the proximity of points in the curvilinear coordinate system corresponds very well to EM simulation. For example, via elements at two ends of U-shaped path can be close to each other in Euclidean distance but the two ends are considered remote in the described system.

For the case when the vias are covered not by paths but by polygons, the preferred coordinate system can be defined as conformal (non-Euclidean) metric on the interior region of the metal polygon(s). Such metric corresponds very closely to quasi-static EM solutions inside the metal. For simple or very large shapes, the non-Euclidean coordinate system does not differ much from the standard Euclidean one and the latter can be used due to computational efficiency.

After via group is extracted, LEM uses this information to establish connectivity between shapes in different layers. There are three cases,

via group is placed at the end of paths;

via group can form a path; and

via group connects two polygons or one polygon and one path.

These three cases are described in details here.

i. Via Group at the End of Path

FIG. 5 shows via group at the end of path. FIG. 5a shows a cross view and FIG. 5b show a top view. LEM first decomposes metal3 layer 41 and metal2 layer 43, and recognizes two paths and assigns Node1 135, Node2 136, Node3 137 and Node4 138 at the end of paths separately. Then a via group 51 of via_m3_m2 47 is recognized at one end of path, and another via group 53 of via_m3_m2 47 is recognized at the other end of the path. Since these two via groups connect end of Metal3 and Metal2 Path, then metal 2 path will be assigned same nodes of metal 3 (namely, Node1 135 and Node2 136), and layer metal3 will be stamped into metal2 path as a property. This procedure continues for via_m1_m2 49 group between metal 2 path 43 and metal 1 path 45. In the end, metal 1 path 45 will have the same node as metal 3 path and is stamped layer metal3 and metal2. Only metal1 path 45 will be provided as output with layer metal1, along with its stamped layer metal3 and metal2.

The following shows the final output as an example of describing the path.

path(′Node1′, ′Node2′, name=’path0′, width=5e−06,

layer=′metal3/metal2/metal1′,
point=[0, 2.5e−06, 10e−5, 2.5e−6], trafo=[1.0, 0.0, 0.0, 1.0, 0.0,
0.0])

In the above example, layer of path is ‘metal3/metal2/metal1’, which means there are three paths connected by via group at the end of them, and their layers are metal3, metal2 and metal1.

ii. Via Path

In many cases vias are placed along path. This is called massive vias. This structure has different effects for the EM model and LEM extracts it as via path.

To extract via path, same as extracting via group at the end of path, LEM will first decompose metal3 and metal2 separately to get two paths, and then group via_m3_m2 which connects metal3 and metal2 path. Then, LEM recognizes that this group can form a via path because it is placed along two paths. LEM then copies nodes of metal3 to metal2, stamping layer metal3 to metal2 path. Via path is associated with metal2 path and it knows itself is connected to metal3 through via path. This procedure continues for metal1 path. In the end, metal1 path will copy nodes of metal3 path and it will be stamped with layer metal3 and metal2. Metal1 path knows itself is connected through via path up to metal3 path.

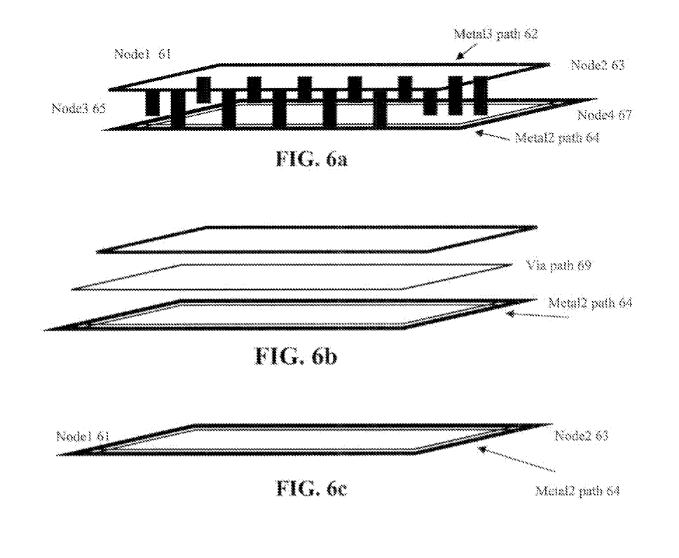

FIGS. 6a-c show an example of the procedure. In FIG. 6a, Metal3 and metal2 are decomposed into metal3 path 62 and metal2 path 64. They are assigned node 1 61, node2 63, node3 65, node4 67 at the end of paths separately. In FIG. 6b, Via path 69 is recognized. In FIG. 6c, Metal2 path 64 copy nodes from Metal3 path and is stamped layer Metal2. Metal2 path knows that Metal2 is connected to Metal3 through via path.

Accordingly, in output stage of the via group at the end of the path, only metal1 path is provided as output as shown below in italicize. Layer of path is ‘metal3//metal2’, where double slash (//) means this path is connected to metal2 and metal3 through viapath.

path(′Node1′, ′Node2′, name=’path0′, width=5e−06,

layer=′metal3//metal2′,
point=[0, 2.5e−06, 10e−5, 2.5e−6], trafo=[1.0, 0.0, 0.0, 1.0, 0.0,
0.0])

iii. Via Group in Polygon

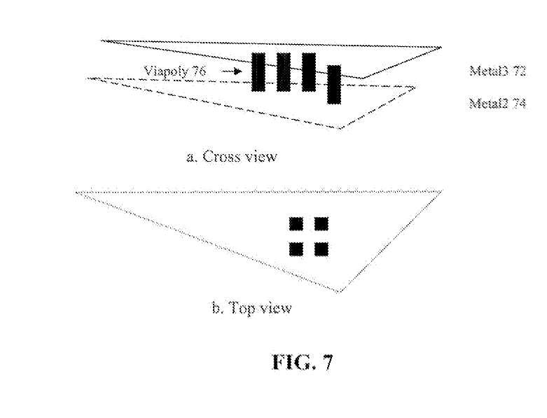

In some cases via group connects two polygons or one polygon and one path as shown in FIG. 7. FIG. 7a shows a cross view and FIG. 7b shows a top view of the polygons. LEM forms a primitive viapoly for the via group and outputs the primitive viapoly in such case. Two polygons of Metal3 72 and Metal2 74 are recognized, and these two polygons will have the Viapoly 76 as their respective properties to establish connectivity. The output is shown as follows for multiple via handling:

viapoly(name=’via1′, point=[5e−6, 4e−6,
10e−6,4e−6,10e−6,5e−6,5e−6,5e−6],

trafo=[1.0, 0.0, 0.0, 1.0, 0.0, 0.0])

polygon(′Node1′, , name=’polygon1′, layer=′metal3′, nodeedge=[1],

point=[0,0, 20e−6,4e−6,10e−6,20e−6], viapoly=[‘via1′],
trafo=[1.0, 0.0, 0.0, 1.0, 0.0, 0.0])

polygon(′Node2′, , name=’polygon1′, layer=′metal2′, nodeedge=[1],

point=[0,0, 20e−6,4e−6,10e−6,20e−6], viapoly=[‘via1′],
trafo=[1.0, 0.0, 0.0, 1.0, 0.0, 0.0])

It can be seen from the above output that two polygons have viapoly property, and this property contains vial, which is the name of viapoly.

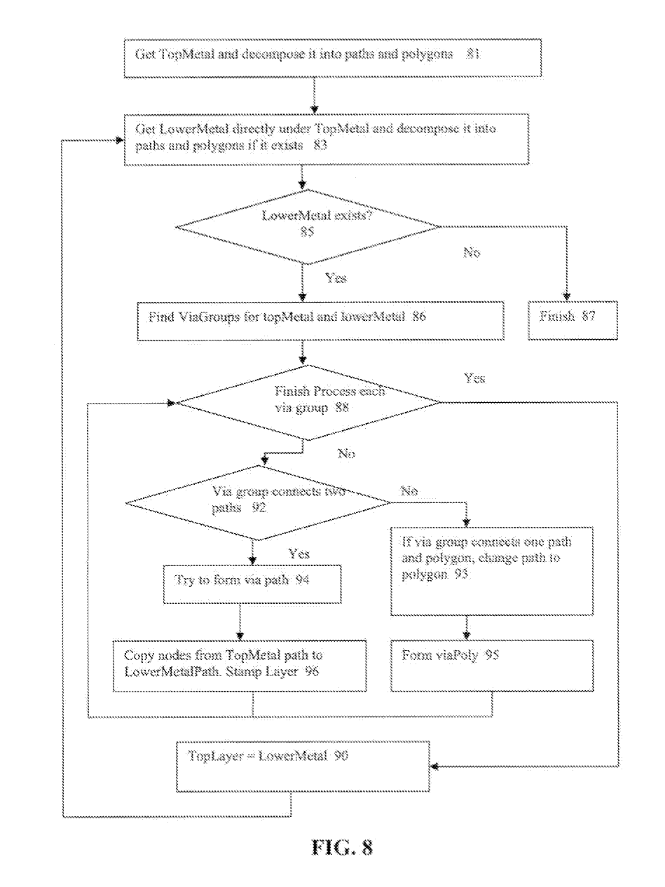

FIG. 8 shows a flow diagram for multiple via handling in accordance to an embodiment of the present invention. The flow begins with step 81; get TopMetal and decompose the TopMetal into paths and polygons. Next, in step 83, Get LowerMetal directly under TopMetal and decompose the LowerMetal into paths and polygons if there exits paths and polygons. In step 85, if LowerMetal does not exists, go to step 87 and the flow is finished. If LowerMetal does exist, step 86 find ViaGroups for TopMetal and Lower Metal is performed. Next, in step 88, if Finish Process each via group is complete, go to step 90 and set TopLayer=LowerMetal. The process returns to step 83; Get LowerMetal directly under TopMetal and decompose it into paths and polygon if it exists. Returning to decision step 88, if the Finish Process each via group is not true, move to decision step 92, via group connects two paths. If via group connects two paths is false, move to step 93 to change path to polygon. Next, move to step 95 and form viapoly. The flow returns to decision step 88. Returning to decision 92, if via group connects two paths is true, next, step 94 tries to form via path. In step 96, copy nodes from TopMetal path to LowerMetalPath and stamp layer is performed. The flow returns to step 88 until Finish Process each via group is complete.

iv. Metal Fill Extraction

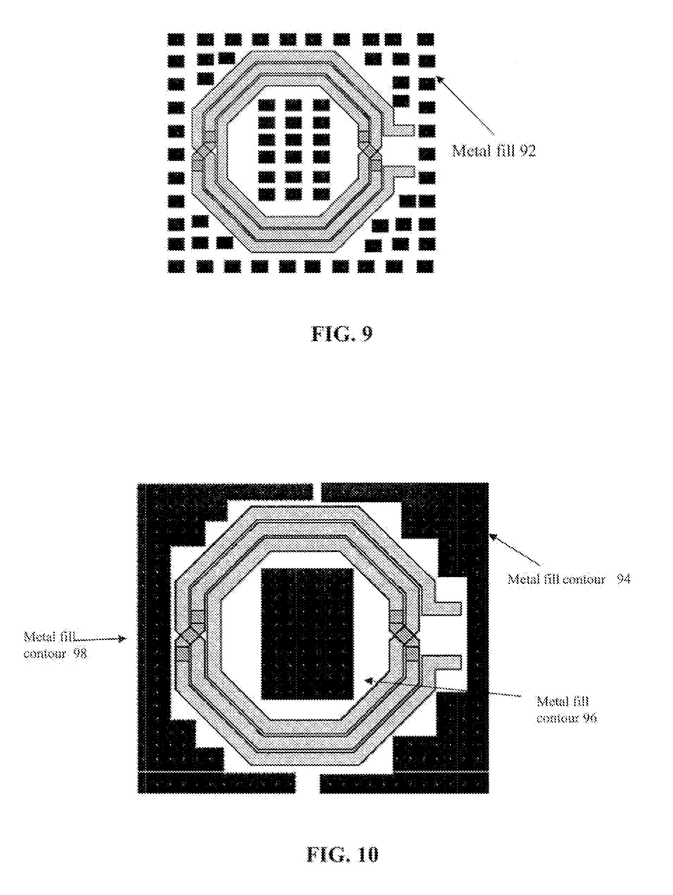

Metal fill is needed for advanced process to satisfy Chemical Mechanical Polishing (CMP) requirements. Metal fill is usually composed of many little pieces of dummy metal shapes filled in the area of the layout where is available and the dummy metal shapes are not connected to any other objects. FIG. 9 shows such an example. Due to the huge number of such small shapes of metal fills 92, it is impractical for EM engine to simulate them if there is no reasonable approximation.

The EM Component to represent the metal fill is a contour polygon of the metal fills. Thus LEM groups metal fill on the same layer together if they are sufficiently close and create a contour polygon of it. LEM then outputs such contour polygon as primitive EM Component (“polygon_metalfill”, for example) along with its metal density.

In FIG. 10, there are two groups. One is inside the inductor, and the other is outside the inductor. LEM will create a contour for these two groups. The final result is shown in FIG. 10. Since the contour of the group which is outside inductor has a hole inside it, LEM splits it into two parts, which are metal fill contour 94 and metal fill contour 98. Metal fill contour 96 is the contour for the group which is inside the inductor. The following shows the output. It can be seen that the density is a property of the metal fills.

polygon_metalfill(name=’metal_fill1’, layer=’metal3’, density=0.716,

point=[point_list_for_metal_fill1], trafo=[1.0,0.0,0.0,1.0,0.0,0.0])

polygon_metalfill(name=’metal_fill1’, layer=’metal3’, density=0.723,

point=[point_list_for_metal_fill2], trafo=[1.0,0.0,0.0,1.0,0.0,0.0])

polygon_metalfill(name=’metal_fill1’, layer=’metal3’, density=0.83,

point=[point_list_for_metal_fill2], trafo=[1.0,0.0,0.0,1.0,0.0,0.0])

It can be seen that the density is a property of the metal fill.

v. Via Grouping

Vias are used to connect adjacent metal layers. To reduce resistance and increase yield, designers usually place many vias in an array format. The huge number of vias makes it very difficult for an EM engine to simulate in a brute-force way. Thus making via group as EM Component and recognizing via group in the extraction stage a very important component to making EM simulation practical. Via groups can form a via path if it placed along paths in adjacent layers, pass nodes from top layer path to lower layer path, or form a primitive viapoly to connect two polygons as disclosed above in multiple layer handling.

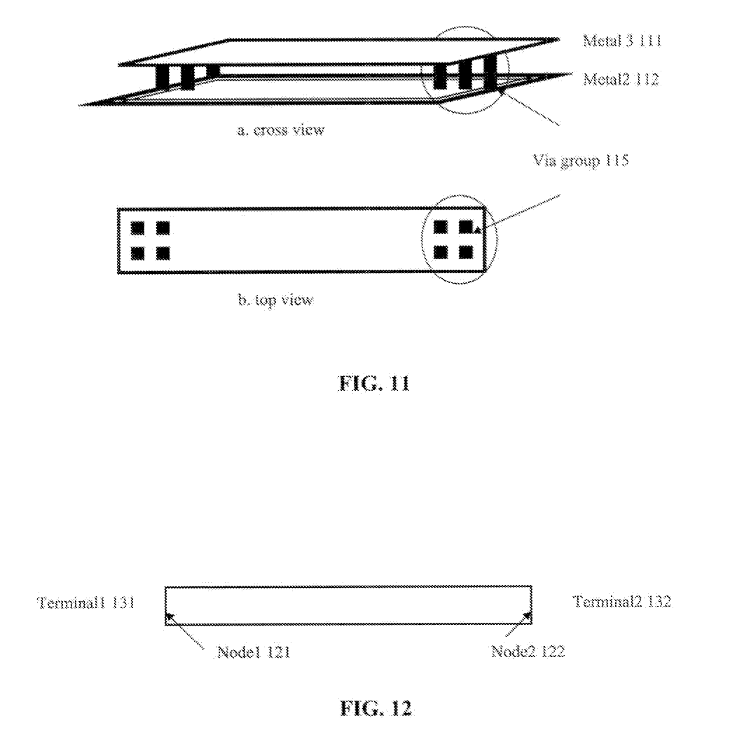

FIG. 11 an example of vias which connect metal3 111 and metal2 112. FIG. 11a shows a cross sectional view and FIG. 11b shows a top view. Since vias in the end of path are very close, LEM groups them together to form one via group 115. There are many ways to find a group. LEM internally use a mesh based approach to find out via group 115. The plane is divided into rectangular meshes with predetermined distance. Vias falling into same rectangle mesh or neighbor meshes are recognized as a group.

### Recognize Terminals

To perform EM simulation, EM engine must recognize terminals. Physically, terminals are places from where external world can access this device; electromagnetically, terminals are where excitation is added. LEM use pin or text attachment to recognize terminals. FIG. 12 shows an example of using a pin or text attachment for terminals.

In FIG. 12, LEM extracts a path with node Node1 121 and Node2 122. In the original layout, there is text or pin Terminal1 131 and Terminal2 132 attached to it. LEM recognizes these pin or text and changes Node1 121 to Terminal1 131, Node2 132 to Terminal2 132. Terminal1 131 and Terminal2 132 become terminals of this device.

The foregoing descriptions of embodiments of the present invention have been presented only for purposes of illustration and description. They are not intended to be exhaustive or to limit the present invention to the forms disclosed. Accordingly, many modifications and variations will be apparent to practitioners skilled in the art. Moreover, the above disclosure is not intended to limit the present invention. The scope of the present invention is defined by the claims.

We claim:

1. A method for electromagnetic simulation of passive structures of a circuit design, comprising the steps of:
recognizing one or more geometries of the passive structures having certain geometric properties and electromagnetic properties;
converting the one or more geometries to one or more primitives based on the geometric properties and numerically equivalent electromagnetic properties of the passive structures;
constructing a physical topology incorporating the converted primitives and unconverted geometries; and
simulating the physical topology to generate electromagnetic modeling of the passive structures of the circuit design.

2. The method of claim 1, wherein in the recognizing step, one or more vias connected to the same primitives having a predetermined distance from one or more other vias of the same primitives are identified as a group.

3. The method of claim 2, wherein a viapoly of the group is created as a primitive.

4. The method of claim 2, wherein a viapath of the group is created as a primitive if the group connects two paths from both ends of these two paths.

5. The method of claim 1, wherein in the recognizing step, one or more paths and rest polygons are identified.

6. The method of claim 5, wherein each of the paths is a polygon using a center line and a distance from the center line.

7. The method of claim 1, wherein in the recognizing step, one or more metal fills are identified.

8. The method of claim 7, wherein the metal fills are equivalently modeled as a group of polygons, where the metal fills are on the same metal layer, are not connected to ports of the passive structures, and are at a predetermined distance from each other.

9. The method of claim 1, wherein in the recognizing step, one or more slots in a metal structure are identified.

10. The method of claim 9, wherein the metal structure includes a slotratio and is attached to the primitives on a solid same metal layer.

11. The method of claim 1, wherein in the converting step, one or more types of primitives are converted based on different accuracy and extraction criteria.

12. The method of claim 1, wherein in the simulating step, one or more electromagnetic solvers are used to generate the electromagnetic modeling of the passive structures.

13. The method of claim 1, wherein in the simulating step, a combination of one or more electromagnetic solvers and static solvers are used for the modeling of the passive structures.

14. A method for electromagnetic simulation of passive structures of a circuit design, comprising the steps of:
recognizing an arbitrary polygon that reflects a certain path for the circuit design wherein the certain path includes holes inside a solid path, and wherein the arbitrary polygon includes one or more geometries of the passive structures having certain geometric properties and electromagnetic properties;
converting the arbitrary polygon into one or more primitives including a slotratio based on the geometric properties and numerically equivalent electromagnetic properties of the slot inside the solid path;
constructing a physical topology incorporating the converted primitives and unconverted geometries; and
simulating the physical topology to generate electromagnetic modeling of the passive structures of the circuit design.

15. The method of claim 14, wherein the slotratio assumes the holes are evenly distributed along the solid path.

16. The method of claim 15, wherein the arbitrary polygon includes:
a plurality of raw polygons on a single layout;
continuous parallel edges forming paths; and
cut paths from the parallel edges to form continuous paths.

17. The method of claim 14, wherein the certain paths include a plurality of vias and in the converting step, the one or more primitives include grouping the plurality of vias within a predetermined distance of each other together.

18. The method of claim 14, wherein the certain paths include a via group at the end of path and in the converting step, the one or more primitives include a metal layer path along with a corresponding stamped layer metal3 and metal2.

19. The method of claim 14, wherein the certain paths include a viapoly and in the converting step, the one or more primitives include a vial property for coupling at least one polygon and one path.

20. The method of claim 14, wherein the certain paths include a plurality metal fills and in the converting step, the one or more primitives include a contour polygon of the metal fills along with a corresponding metal density.
